(19) United States
(12) Patent Application Publication
(10) Pub. No.: US 2023/0359981 A1
(43) Pub. Date: Nov. 9, 2023

(54) PHYSICAL INTERNET DYNAMIC PRINCIPAL INTERFACE NODE (PIN) PORT SELECTION

(71) Applicant: Inlecom Group BV, Bruxelles (BE)

(72) Inventors: Konstantinos ZAVITSAS, London (GB); Panayotis KATSOULAKOS, Haywards Heath (GB); Efstathios ZAVVOS, Athens (GR); Antonios MYGIAKIS, Chalandri (GR); Aristides HALATSIS, Thessaloniki (GR); Patrick J. O'Sullivan, Dublin (IE)

(73) Assignee: Inlecom Group BV, Bruxelles (BE)

(21) Appl. No.: 17/735,398

(22) Filed: May 3, 2022

(51) Int. Cl. G06Q 10/08

(52) U.S. Cl. CPC G06Q 10/08355; G06Q 10/0831

(57) ABSTRACT

Physical Internet (PI) dynamic principal interface node (PIN) port selection includes selecting a primary maritime port as a PIN in a routing of freight aboard a sea going vessel from an origin node to a destination node in a PI model and receiving a disruption event in the PI model indicating an inability of the vessel to berth at the primary maritime port. A cluster of alternative PINs is determined in connection with the destination node of the PI model and a routing score computed for each alternative PIN based upon a cost of routing the freight through each alternative PIN. Finally, a new routing is established in the PI model utilizing an optimal alternative PIN in lieu of the selected PIN based upon a corresponding routing score, and a message is transmitted to the vessel to divert to a secondary maritime port associated with the optimal alternative PIN.

### BACKGROUND OF THE INVENTION

### Field of the Invention

The present invention relates to the technical field of Physical internet (PI) and more particularly to PIN port selection for PI enabled routing.

### Description of the Related Art

The Physical Internet or “PI” is an open global logistics system founded on physical, digital, and operational interconnectivity, through encapsulation, interfaces and protocols. More than a decade ago, Professor Benoit Montreuil, a professor in the department of operations and decision systems at the Universite Laval in Quebec and a member of the College-Industry Council on Material Handling Education (CICMHE) conceived of PI as an improvement to distribution and logistics by applying some of the principles of the digital Internet to the physical movement of goods. To that end, the Physical Internet centers around the basic notion that a shipping container, as a package encapsulator, behaves like packets of the well-known Internet Protocol (IP) of the digital Internet, and moves from an origin to a destination along a route according to transport directives akin to the transport control protocol (TCP) of the digital Internet.

The PI models the entirety of the logistics supply chain from source to sink inclusive of sea, air, road and rail. As noted in Patrick B. M. Fahim et al., On the Evolution of Maritime Ports Towards the Physical Internet (Futures 134, Aug. 27, 2021), the maritime port forms an important component of the holistic logistics supply chain linking sea transport to overland transport. Thus, a bottleneck can occur at the maritime port where the transition of freight from ship to shore can be slowed owing to several factors including the processing of necessary papers relating to the freight, the speed at which the freight can be physically offloaded from ship to shore and then subsequently placed on road or rail transport, and of course the throughput available on the roadway and railway corridors leading from the maritime port into the hinterland.

Consequently, managing the movement of freight from ship to shore through a maritime port requires substantial advance planning. Indeed, it is often the case that many different maritime ports are able to process freight en route to a same destination and that a specific one of those ports is selected on the basis of optimal cost, optimal throughput or ecologically minimal impact. In PI, a maritime port is classified as a principal interface node or “PIN” referencing the primary interface between sea and land and a set of maritime ports through which freight can be forwarded to a common destination is referred to as a PIN cluster. Optimally routing freight in the PI from sea to land requires the a priori selection of a PIN from a PIN cluster according to the criteria established for the corresponding PI model. Once selected, the PI model presumes that the freight will be received at the maritime port of the selected PIN.

In reality though, it can never be presumed that a ship is able to reach a designated maritime port. Several factors influence the possibility that a ship carrying freight and destinated for a designated port may be required to divert to a different port. Primary examples include weather and traffic, but other possibilities include labor shortages at the designated port, or mechanical failures of offloading equipment at the port. In any instance, optimization of the PI model will be disrupted. As such in the event of a port disruption, a decision must be made somewhat quickly depending upon the distance of the ship from the designated port. Yet, the decision making, expedited as it may be, is rife with consequence, and selecting an alternative maritime port within the cluster can result in a failure to meet the time and cost constraints of the shipment of the freight, as well as impart an unacceptable ecological cost in terms of a higher level of emissions.

### BRIEF SUMMARY OF THE INVENTION

Embodiments of the present invention address technical deficiencies of the art in respect to maritime port selection in supply chain logistics. To that end, embodiments of the present invention provide for a novel and non-obvious method for PI dynamic PIN port selection. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for PI dynamic PIN port selection begins with a selection of a primary maritime port as a PIN in a routing of freight aboard a sea going vessel from an origin node to a destination node in a PI model. Thereafter, a disruption event can be received in the PI model in connection with the selected PIN, the event indicating an inability of the sea going vessel to berth at the primary maritime port. In response to the event, the method determines a cluster of alternative PINs for the original PIN in connection with the hinterland distribution nodes of the PI model. The method then computes a routing score for each of the alternative PINs based upon a cost of routing the freight through each of the alternative PINs. Finally, the method establishes a new routing in the PI model utilizing an optimal one of the alternative PINs in lieu of the selected PIN based upon a corresponding routing score, and the method transmits a message to the sea going vessel to divert to a secondary maritime port associated with the optimal one of the alternative PINs.

In one aspect of the embodiment, the routing score for each maritime port of a corresponding one of the alternative PINs is computed based upon a corridor connectivity index combining an inland connectivity value and a maritime connectivity value. To that end, as one option, the maritime connectivity value is determined from a port liner shipping connectivity index previously determined for the maritime port of the corresponding one of the alternative PINs. As another option, the inland connectivity value for the maritime port is determined from table values associated with port capacity at the maritime port, process quality in processing freight at the maritime port, service frequency of connecting transport services at the maritime port, service quality at the maritime port, digital connectivity at the maritime port and infrastructure quality at the maritime port.

In another aspect of the embodiment, the routing score is computed for each of the alternative PINs on a container by container basis amongst all containers of the freight and with respect to a delivery time constraint of each of the containers, a delivery type of each of the containers and at least one emissions related preference. In this regard, optionally at least two alternative ones of the PINs are selected based a computation of an optimal routing score for one portion of the freight and a first one of the alternative PINs, and an optimal routing score for a second portion of the freight and a second one of the alternative PINs. As such, an alternative one of the PINs may be selected based upon an optimal routing score for a portion of the freight considered more important than another portion of the freight.

In another embodiment of the invention, a data processing system adapted for PI dynamic PIN port selection includes a host computing platform of one or more computers, each with memory and one or processing units including one or more processing cores. The system further includes a PIN port selection module. The module includes computer program instructions enabled while executing in the memory of at least one of the processing units of the host computing platform to select a primary maritime port as a PIN in a routing of freight aboard a sea going vessel from an origin node to a destination node in a PI model, to receive a disruption event in the PI model in connection with the selected PIN indicating an inability of the sea going vessel to berth at the primary maritime port and in response, to determine a cluster of alternative PINs for the selected PIN in connection with the destination node of the PI model. The program instructions further compute a routing score for each of the alternative PINs based upon a cost of routing the freight through each of the alternative PINs, establish a new routing in the PI model utilizing an optimal one of the alternative PINs in lieu of the selected PIN based upon a corresponding routing score and transmit a message to the sea going vessel to divert to a secondary maritime port associated with the optimal one of the alternative PINs.

In this way, the technical deficiencies of the disruption of a planned routing to a designated PIN are overcome owing to the ability of the PIN selection module to determine a cluster of alternative PINs for the designated PIN and select one or more of the alternative PINs in the cluster according to a score accounting for the cost of routing freight through each of the alternative PINs. In particular, it is a distinct advantage of the foregoing process to account in the score for a corridor connectivity index that combines both an inland connectivity value referring to the cost of routing freight from a prospective one of the alternative PINs to the destination, and a maritime connectivity value referring to the cost of processing freight at the maritime port associated with a prospective one of the alternative PINs. To the extent that the PIN selection module identifies an optimal one or more alternative PINs in response to detecting a disruption event at the designated PIN, the re-routing of the freight in the PI model can occur well in advance of the sea going vessel arriving at the maritime port of the designated PIN.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of PI dynamic PIN port selection;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for PI dynamic PIN port selection. In accordance with an embodiment of the invention, a maritime port selected as a primary PIN in a routing of a PI model for freight onboard a seaborn vessel can become inaccessible prior to the arrival of the vessel at the maritime port. In consequence, a cluster of alternative PINs can be selected in the PI model, each of the alternative PINs having an associated maritime port in geographic proximity to that of the primary PIN and able to provide a routing for the freight to an intended destination. A cost of routing the freight through the different alternative PINs is then computed as a function of a corridor connectivity index which can include an aggregation of inland connectivity and maritime connectivity for the corresponding maritime port. A best scoring alternative PIN is then selected and the PI model updated to account for the alternative PIN. Finally, a message is provided to the seaborn vessel directing a diversion to a maritime port associated with the alternative PIN.

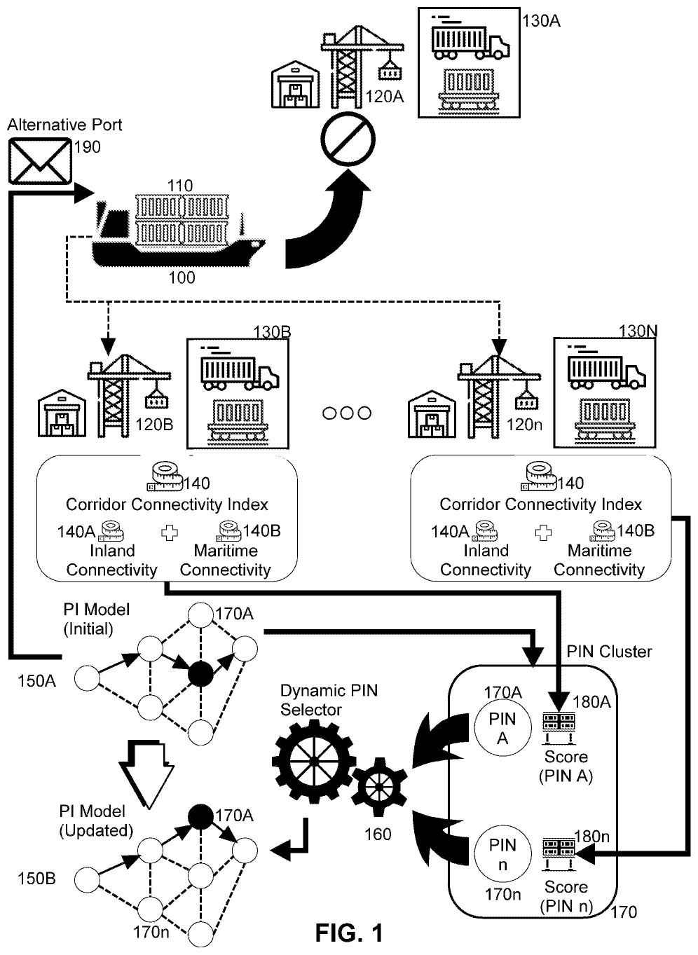

In illustration of one aspect of the embodiment, FIG. 1 pictorially shows a process of for PI dynamic PIN port selection. As shown in FIG. 1, a seaborn vessel 100 carrying freight 110 in the form of one or more containers travels along a routing defined according to an initial PI model 150 towards a designated maritime port 120A associated with a PIN of the initial PI model 150 and including inland connectivity 130—namely roadway transport and rail transport—linking the designated maritime port 120A to one or more destinations for corresponding containers of the freight 110. Prior to berthing at the designated maritime port 120A, a fault condition arises inhibiting the berthing of the seaborn vessel 100 at the designated maritime port 120A, for instance a weather, traffic or labor condition at the designated maritime port 120A.

In response to the fault condition, dynamic PIN selector 160 identifies two or more alternative maritime ports 120B, 120n with associated inland connectivity 130B, 130n and defined by corresponding PINs 170A, 170n in the initial PI model 150A. Thereafter, the dynamic PIN selector 160 computes a score 180A, 180n for each of the PINs 170A, 170n. In this regard, the dynamic PIN selector 160 computes the score 180A, 180n based upon a corridor connectivity index 140 for each of the associated maritime ports 120B, 120n. The corridor connectivity index 140 includes an aggregation of both inland connectivity values 140A and also maritime connectivity values 140B for a corresponding one of the maritime ports 120B, 120n and the associated inland connectivity 130B, 130n.

More specifically, maritime connectivity values 140B include pre-stored tabular values pertaining to the ability of a particular port to process freight therethrough. One example of a pre-stored tabular value for maritime connectivity is the well-known port level liner shipping connectivity index (LCSI), the higher value of which reflects an ease in accessing a high capacity and frequency of global maritime freight transport. Likewise, the inland connectivity values 140A include pre-stored tabular values pertaining to the capacity of an associated maritime port, a numerical value associated with the efficiency and ease of processing of freight through the maritime port including customs and border clearance, logistics service competency and timeliness of processing, a frequency of service of rail, barge and short sea services, a numerical value associated with the quality of service of the logistics of offloading and handling freight at the maritime port, the digital connectivity of the maritime port including an ability to track and trace consignments, the ability to create and book routings online, the ability to locate shipping information online, the ability to measure a carbon footprint of the operations of the maritime port, and the ability to submit and process customs declarations online, and survey values regarding the quality of the infrastructure at the maritime port.

The dynamic PIN selector 160 having computed a score 180A, 180n for each of the PINs 170A, 170n, the dynamic PIN selector 160 then selects a highest scoring one of the PINs 170A, 170n and updates the initial PI model 150A to reflect the selected one of the PINs 170A, 170n so as to produce an updated PI model 150B. Finally, the dynamic PIN selector 160 transmits a message 190 to the seaborn vessel 100 specifying a corresponding one of the maritime ports 120B, 120n for the selected one of the PINs 170A, 170n. In this way, the seaborn vessel 100 diverts to the corresponding one of the maritime ports 120B, 120n determined to be most optimal for routing the freight 110 to the intended destination notwithstanding the inhibition of berthing at the designated maritime port 120A.

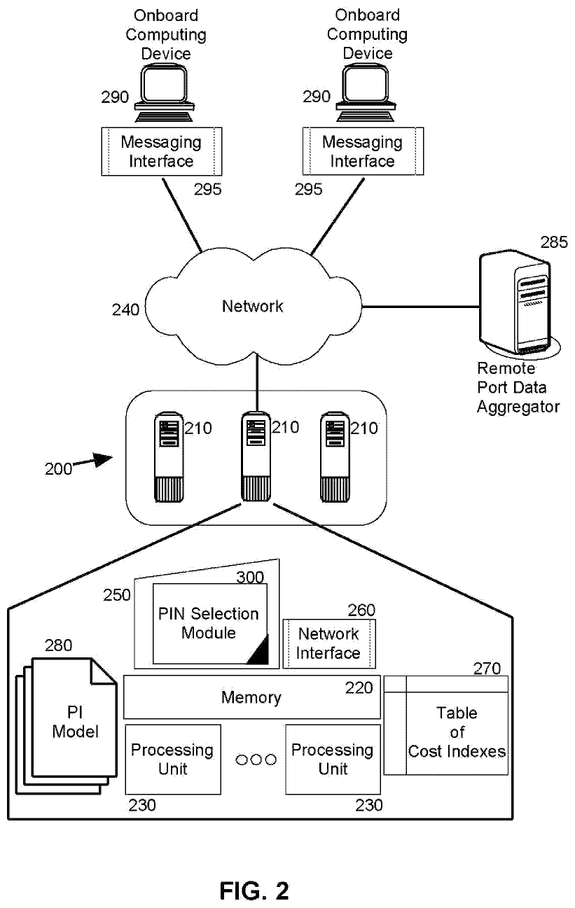

Aspects of the process described in connection with FIG. 1 can be implemented within a data processing system. In further illustration, FIG. 2 schematically shows a data processing system adapted to perform PI dynamic PIN port selection. In the data processing system illustrated in FIG. 1, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

On or more onboard computing devices 290 for respective seaborn vessels are communicatively coupled to the host computing platform 200 over data communications network 240, each of the devices 290 communicating with the host computing platform 200 through a respective messaging interface 295. Notably, one or more different PI models 280 are stored in the memory 220, each defining a different hierarchy of nodal relationships between an origin node and a destination node for a container and a routing of the container from the origin node to the destination node. As well, a table of cost indexes 270 is stored in the memory 220 and includes different values for different cost components of both inland connectivity values and also maritime connectivity values. To that end, a remote port data aggregator 285 is communicatively coupled to the host computing platform 200 over the data communications network 240 and provides on a periodic basis one or more values stored in the table of cost indexes 270.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for PI dynamic PIN port selection. Specifically, the program instructions during execution receive an indication of a fault condition in respect to a designated maritime port for a seaborn vessel.

The program instructions, during execution, respond to an indication of a fault condition in the scheduled berthing of a seaborn vessel at a designated maritime port corresponding to a PIN in an associated one of the PI models 280 by determining a cluster of alternative PINs with associated maritime ports and the computation of a score for each of the alternative PINs. In particular, the program instructions compute the score for each of the alternative PINs based upon a corridor connectivity index that includes an aggregation of both inland connectivity values and also maritime connectivity values for a corresponding one of the maritime ports set forth in the table of cost indexes 270. Based upon the score of each of the alternative PINs, the program instructions select one or more of the alternative PINs for the seaborn vessel, each of the alternative PINs corresponding to a different alternative maritime port. Finally, the program instructions transmit a message over the data communications network 240 to a messaging interface of an onboard computing device 290 of the seaborn vessel directing a diversion to the alternative maritime port of the selected alternative PIN.

Then, with an alternative maritime port having been selected, inland connectivity can be dynamically coordinated in an automated fashion. Specifically, one or more providers required for the movement of the freight from the alternative maritime port to a destination within the hinterland can be identified and smart contracts established for of the providers. For instance, a network accessible directory of providers can be consulted for each node of an inland routing to a determined destination so as to locate a network address at which a smart contract can be accessed over the data communications network 240 for different hinterland transporters. With the network address in hand for each of the required providers for the hinterland transport of the freight, a smart contract at each network address can be consummated according to the terms of the smart contract and then automatically executed. Concurrently, a pre-existing smart contract for hinterland providers at the designated maritime port can be terminated in accordance with the terms and conditions of the pre-existing smart contract.

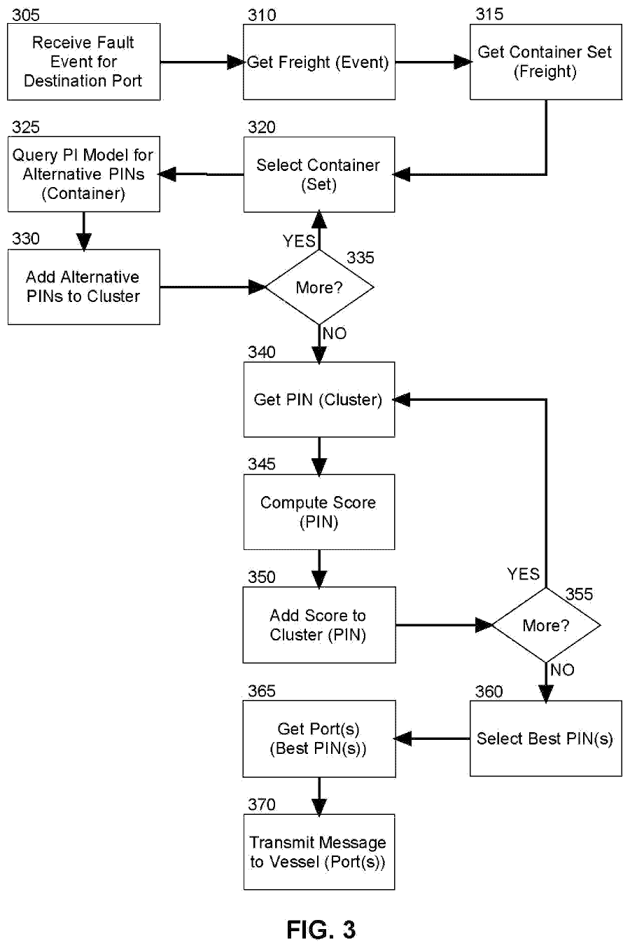

In further illustration of an exemplary operation of the module, FIG. 3 is a flow chart illustrating one of the aspects of the process of FIG. 1. Beginning in block 305, a fault event is received for a destination maritime port for a seaborn vessel. In block 310, freight for the event is determined and in block 315, a container set of containers is retrieved. In block 320, a first container in the set is selected and in block 325, a PI model for the container is queried for alternative PINs. In block 330, the alternative PINs for the container are added to a cluster data structure and in decision block 335, if additional containers remain to be processed in the set, the process returns to block 320 in which a next container is selected for processing. In decision block 335, when no further containers remain to be processed in the set, the process continues in block 340.

In block 340, a first PIN for the cluster is selected for processing. Then, in block 345, a score is computed for the PIN based upon an aggregation of pre-stored tabular information regarding both inland connectivity values and also maritime connectivity values for a corresponding one of the maritime ports. In block 350 the score is added to the cluster for the PIN. Then, in decision block 355, it is determined if further PINs remain in the cluster. If so, the process returns to block 340 wherein a next PIN in the cluster is selected for processing. In decision block 355, when no further PINs remain in the cluster to be processed, in block 360 the PINs associated with the best one or more scores are selected and the corresponding maritime ports identified in block 365. Then, in block 370, a message is transmitted to the seaborn vessel directing a diversion to the one or more ports.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for physical Internet (PI) dynamic principal interface node (PIN) port selection comprising:
selecting a primary maritime port as a PIN in a routing of freight aboard a sea going vessel from an origin node to a destination node in a PI model;
receiving a disruption event in the PI model in connection with the selected PIN indicating an inability of the sea going vessel to berth at the primary maritime port;
determining a cluster of alternative PINs for the selected PIN in connection with the destination node of the PI model;
computing a routing score for each of the alternative PINs based upon a cost of routing the freight through each of the alternative PINs;
establishing a new routing in the PI model utilizing an optimal one of the alternative PINs in lieu of the selected PIN based upon a corresponding routing score; and,
transmitting a message to the sea going vessel to divert to a secondary maritime port associated with the optimal one of the alternative PINs.

2. The method of claim 1, wherein the routing score for each maritime port of a corresponding one of the alternative PINs is computed based upon a corridor connectivity index combining an inland connectivity value and a maritime connectivity value.

3. The method of claim 2, wherein the maritime connectivity value is determined from a port liner shipping connectivity index previously determined for the maritime port of the corresponding one of the alternative PINs.

4. The method of claim 2, wherein the inland connectivity value for the maritime port is determined from table values associated with port capacity at the maritime port, process quality in processing freight at the maritime port, service frequency of connecting transport services at the maritime port, service quality at the maritime port, digital connectivity at the maritime port and infrastructure quality at the maritime port.

5. The method of claim 1, wherein the routing score is computed for each of the alternative PINs on a container by container basis amongst all containers of the freight and with respect to a delivery time constraint of each of the containers, a delivery type of each of the containers and at least one emissions preference.

6. The method of claim 5, wherein at least two alternative ones of the PINs are selected based a computation of an optimal routing score for one portion of the freight and a first one of the alternative PINs, and an optimal routing score for a second portion of the freight and a second one of the alternative PINs.

7. A data processing system adapted for physical Internet (PI) dynamic principal interface node (PIN) port selection, the system comprising:
a host computing platform comprising one or more computers, each with memory and one or processing units including one or more processing cores; and,
a PIN port selection module comprising computer program instructions enabled while executing in the memory of at least one of the processing units of the host computing platform to perform:
selecting a primary maritime port as a PIN in a routing of freight aboard a sea going vessel from an origin node to a destination node in a PI model;
receiving a disruption event in the PI model in connection with the selected PIN indicating an inability of the sea going vessel to berth at the primary maritime port;
determining a cluster of alternative PINs for the selected PIN in connection with the destination node of the PI model;
computing a routing score for each of the alternative PINs based upon a cost of routing the freight through each of the alternative PINs;
establishing a new routing in the PI model utilizing an optimal one of the alternative PINs in lieu of the selected PIN based upon a corresponding routing score; and,
transmitting a message to the sea going vessel to divert to a secondary maritime port associated with the optimal one of the alternative PINs.

8. The system of claim 7, wherein the routing score for each maritime port of a corresponding one of the alternative PINs is computed based upon a corridor connectivity index combining an inland connectivity value and a maritime connectivity value.

9. The system of claim 8, wherein the maritime connectivity value is determined from a port liner shipping connectivity index previously determined for the maritime port of the corresponding one of the alternative PINs.

10. The system of claim 8, wherein the inland connectivity value for the maritime port is determined from table values associated with port capacity at the maritime port, process quality in processing freight at the maritime port, service frequency of connecting transport services at the maritime port, service quality at the maritime port, digital connectivity at the maritime port and infrastructure quality at the maritime port.

11. The system of claim 7, wherein the routing score is computed for each of the alternative PINs on a container by container basis amongst all containers of the freight and with respect to a delivery time constraint of each of the containers, a delivery type of each of the containers and at least one emissions preference.

12. The system of claim 10, wherein at least two alternative ones of the PINs are selected based a computation of an optimal routing score for one portion of the freight and a first one of the alternative PINs, and an optimal routing score for a second portion of the freight and a second one of the alternative PINs.

13. A computing device comprising a non-transitory computer readable storage medium having program instructions stored therein, the instructions being executable by at least one processing core of a processing unit to cause the processing unit to perform a method for physical Internet (PI) dynamic principal interface node (PIN) port selection, the method including:
selecting a primary maritime port as a PIN in a routing of freight aboard a sea going vessel from an origin node to a destination node in a PI model;
receiving a disruption event in the PI model in connection with the selected PIN indicating an inability of the sea going vessel to berth at the primary maritime port;
determining a cluster of alternative PINs for the selected PIN in connection with the destination node of the PI model;
computing a routing score for each of the alternative PINs based upon a cost of routing the freight through each of the alternative PINs;
establishing a new routing in the PI model utilizing an optimal one of the alternative PINs in lieu of the selected PIN based upon a corresponding routing score; and,
transmitting a message to the sea going vessel to divert to a secondary maritime port associated with the optimal one of the alternative PINs.

14. The device of claim 13, wherein the routing score for each maritime port of a corresponding one of the alternative PINs is computed based upon a corridor connectivity index combining an inland connectivity value and a maritime connectivity value.

15. The device of claim 14, wherein the maritime connectivity value is determined from a port liner shipping connectivity index previously determined for the maritime port of the corresponding one of the alternative PINs.

16. The device of claim 14, wherein the inland connectivity value for the maritime port is determined from table values associated with port capacity at the maritime port, process quality in processing freight at the maritime port, service frequency of connecting transport services at the maritime port, service quality at the maritime port, digital connectivity at the maritime port and infrastructure quality at the maritime port.

17. The device of claim 13, wherein the routing score is computed for each of the alternative PINs on a container by container basis amongst all containers of the freight and with respect to a delivery time constraint of each of the containers, a delivery type of each of the containers and at least one emissions preference.

18. The device of claim 17, wherein at least two alternative ones of the PINs are selected based a computation of an optimal routing score for one portion of the freight and a first one of the alternative PINs, and an optimal routing score for a second portion of the freight and a second one of the alternative PINs.
